(19) United States
(12) Patent Application Publication
(10) Pub. No.: US 2012/0299871 A1
(43) Pub. Date: Nov. 29, 2012

(54) INPUT DEVICE, DISPLAY DEVICE, AND ELECTRONIC DEVICE

(75) Inventor: Yoshio Miyazaki, Kirishima-shi (JP)

(73) Assignee: KYOCERA CORPORATION, Kyoto-shi (JP)

(21) Appl. No.: 13/481,311

(22) Filed: May 25, 2012

(30) Foreign Application Priority Data
May 27, 2011 (JP) 2011-119432

(51) Int. Cl. G06F 3/045; G09G 3/30

(52) U.S. Cl. 345/174; 345/76

(57) ABSTRACT

An input device has a base, detection electrodes provided on or above the base, detection interconnects provided on or above the base and electrically connected to the detection electrode, and a reinforcing member provided on or above the base and positioned closer to end face side of the base than the detection interconnect.

### BACKGROUND OF THE INVENTION

1. Field of the Invention

The present invention relates to an input device, a display device, and an electronic device.

2. Description of Related Art

A capacitive-type touch panel, for example, is a known input device (for example Japanese Laid-open Patent Publication No. 2008-97283 and Japanese Laid-open Patent Publication No. 2008-310551). A capacitive-type touch panel detects the input position by sensing a change in the electrostatic capacitance between the finger and a detection electrode.

Such an input device has a base, detection electrodes provided on the base, and detection interconnections provided on the base and electrically connected to the detection electrodes.

When a chip occurs in the end face of the base, a crack might grow from the chip toward the inside of the base. Also, when a crack occurs at the end face of the base, it might grow further toward the inside of the base.

When a crack grows inside the base, the strength of the base is reduced. Also, water and the like intrude from the crack, which reach the detection interconnects, causing corrosion of the detection interconnects. Growth of a crack inside the base in this manner can reduce the reliability of the input device.

### SUMMARY OF THE INVENTION

One aspect of the input device of the present invention has a base; a detection electrode provided on or above the base; a detection interconnect provided on or above the base and electrically connected to the detection electrode; and a reinforcing member provided on or above the base and positioned closer to end face side of the base than the detection interconnect.

Another aspect of the input device of the present invention is an input device having an input region and a non-input region; and including a base having a first main surface, a second main surface positioned on the opposite side from the first main surface, and an end face positioned between the first main surface and the second main surface; a detection electrode provided on or above the second main surface of the base in the input region; a detection interconnect provided on or above the second main surface of the base in the non-input region and electrically connected to the detection electrode; and a reinforcing member provided on or above the second main surface of the base in the non-input region and positioned between the detection interconnect and the end part of the end face of the base.

Another aspect of the input device of the present invention has the above-noted input device; a display panel arranged to face the input device; and an enclosure housing the display panel.

Another aspect of the electronic device of the present invention has the above-noted display device.

### BRIEF DESCRIPTION OF THE DRAWINGS

FIG. 1 is a plan view showing the general constitution of an input device according to an embodiment of the present invention.

FIG. 2 is a cross-sectional view along the cutting line I-I shown in FIG. 1.

FIG. 3 is a cross-sectional view along the cutting line II-II shown in FIG. 1.

FIG. 4 is a cross-sectional view along the cutting line III-III shown in FIG. 1.

FIG. 5 is a cross-sectional view showing the general constitution of a display device according to this embodiment of the present invention.

FIG. 6 is an oblique view showing the general constitution of a portable terminal according to this embodiment of the present invention.

FIG. 7 is a plan view showing the general constitution of an input device according to a variation example 1.

FIG. 8 is a cross-sectional view along the cutting line IV-IV shown in FIG. 7.

FIG. 9 is a plan view showing the general constitution of an input device according to a variation example 2.

FIG. 10 is a cross-sectional view along the cutting line V-V shown in FIG. 9.

### DESCRIPTION OF THE PREFERRED EMBODIMENTS

An embodiment of the present invention will be described below, with reference to the drawings.

In each of the drawings referred to below, the main members among the constituent members of the embodiments are simplified for convenience. The input device, the display device, and the electronic device according to the present invention can be provided with additional members that are not shown in the drawings.

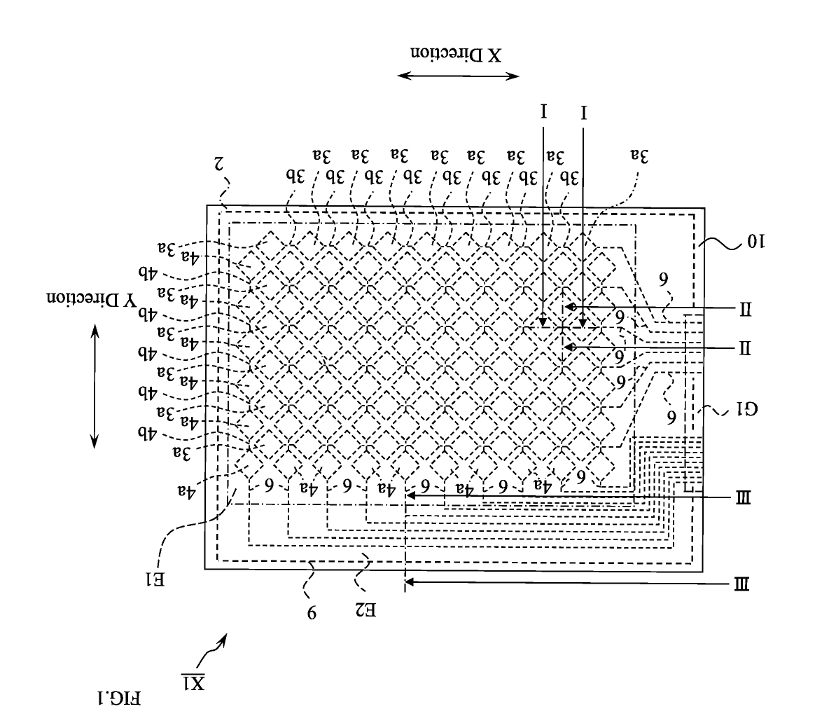

As shown in FIG. 1, an input device X1 according to the present embodiment is a projection-type capacitive touch panel. The input device X1 has an input region E1 and a non-input region E2. The input region E1 is a region in which a user can perform an input operation. The non-input region E2 is a region in which the user cannot perform an input operation. Although the non-input region E2 in the present embodiment is positioned outside the input region E1 to surround the input region E1, the invention is not limited thereto. For example, the non-input region E2 can be positioned inside the input region E1

The input device X1 is not limited to such a projection type capacitive touch panel, and can be a surface-type capacitive touch panel. Additionally, the input device X1 can be a resistive-film type touch panel, a surface acoustic wave touch panel, an infrared-type touch panel, or an electromagnetic induction-type touch panel.

As shown in FIG. 1 to FIG. 4, the input device X1 has a base 2.

The base 2 supports, in the input region E1, first detection electrodes 3a, first connection electrodes 3b, second detection electrodes 4a, and second connection electrodes 4b. The base 2 supports, in the non-input region E2, the detection interconnects 6. The base 2 has a first main surface 2a, a second main surface 2b, and an end face 2c. The first main surface 2a is the surface operated by the user, via a first protective sheet 10. The second main surface 2b is the surface positioned on the opposite side from the first main surface 2a. The end face 2c is the surface positioned between the first main surface 2a and the second main surface 2b.

The base 2 has insulating properties. The base 2 has translucency with respect to incident light in a direction that intersects with the first main surface 2a and the second main surface 2b. In this specification, the term “translucency” means transmissive with respect to visible light. Although the outer shape of the base 2 according to the present embodiment is rectangular when seen in plan view, the invention is not limited thereto. The outer shape of the base 2 can be circular, triangular, or the like when seen in plan view. The constituent material of the base 2 can be glass, plastic, or the like. When the base 2 is made of glass, it can be one having been chemically tempered by ion exchange in order to improve the strength.

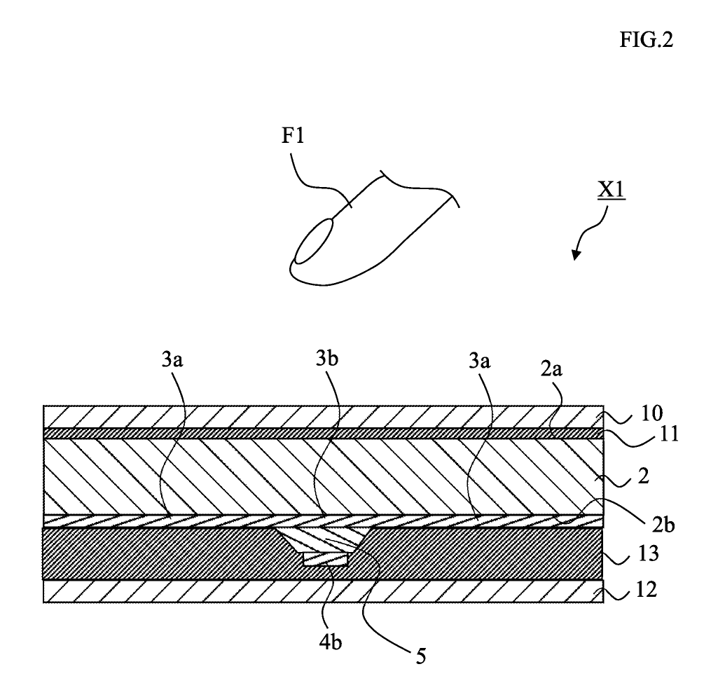

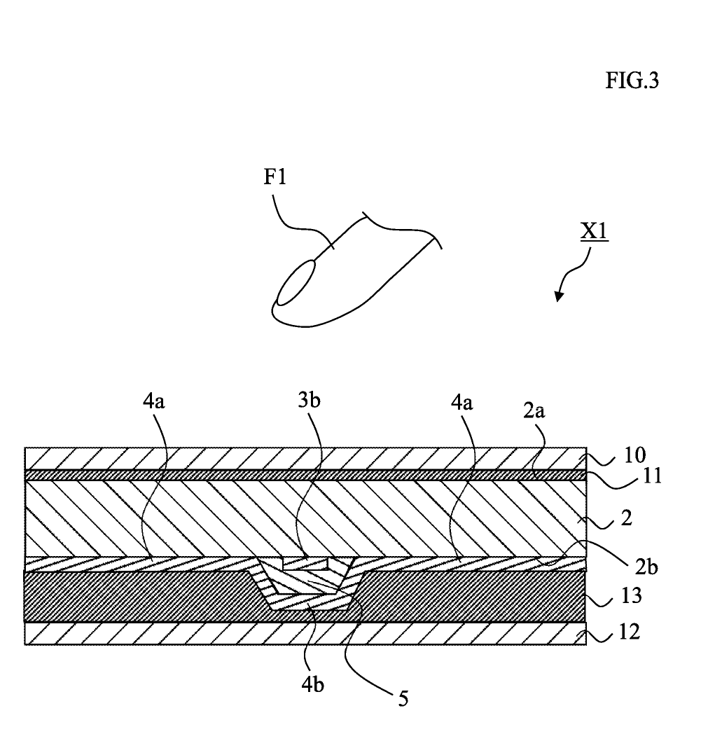

As shown in FIG. 2 and FIG. 3, first detection electrodes 3a, first connection electrodes 3b, second detection electrodes 4a, second connection electrodes 4b, and insulators 5 are provided on or above the second main surface 2b of the base 2 in the input region E1.

In this specification, the phrase “first detection electrodes 3a is provided on or above the second main surface 2b of the base 2” means that the first detection electrodes 3a is provided directly on the second main surface 2b of the base 2, or is provided above the second main surface 2b of the base 2 indirectly, via an intervening member. Similar construction should apply to the configuration of the first connection electrodes 3b, the second detection electrodes 4a, the second connection electrodes 4b, and the insulators 5. The same applies to the other constituent elements described below.

The first detection electrodes 3a generate an electrostatic capacitance between them and a finger F1. The first detection electrodes 3a detect the input position in the Y direction of the finger F1 of the user, which is proximity to the input region E1. The first detection electrodes 3a are provided on or above the second main surface 2b of the base 2, with a prescribed spacing therebetween along the X direction. While the first detection electrodes 3a in the present embodiment, from the standpoint of improving the detection sensitivity, are formed to be substantially diamond-shaped when seen in plan view, the invention is not limited thereto.

The first connection electrodes 3b electrically connect neighboring first detection electrodes 3a. The first connection electrodes 3b are provided on or above the second main surface 2b of the base 2.

The second detection electrodes 4a generate an electrostatic capacitance between them and the finger F1. The second detection electrodes 4a detect the input position in the X direction of the finger F1 of the user, which is proximity to the input region E1. The second detection electrodes 4a are provided on or above the second main surface 2b of the base 2, with a prescribed spacing therebetween along the Y direction. While the second detection electrodes 4a in the present embodiment, from the standpoint of improving the detection sensitivity, are formed to be substantially diamond-shaped when seen in plan view, the invention is not limited thereto.

The second connection electrodes 4b have electrically connect neighboring second detection electrodes 4a. The second connection electrodes 4b are provided on the insulators 5, straddling the insulators 5 to be electrically insulated from the first connection electrodes 3b. In this case, the insulators 5 are provided on or above the second main surface 2b of the base 2, to cover the first connection electrodes 3b. The constituent material of the insulators 5 can be, for example, acrylic resin, epoxy resin, silicone resin, or urethane resin.

The constituent material of the above-noted first detection electrodes 3a, first connection electrodes 3b, second detection electrodes 4a, and second connection electrodes 4b can be an electrically conductive member having translucency. ITO (indium tin oxide), IZO (indium zinc oxide), ATO (antinomy tin oxice), AZO (Al-doped zinc oxide), tin oxide, zinc oxide, or an electrically conductive polymer are examples of conductive materials that have translucency.

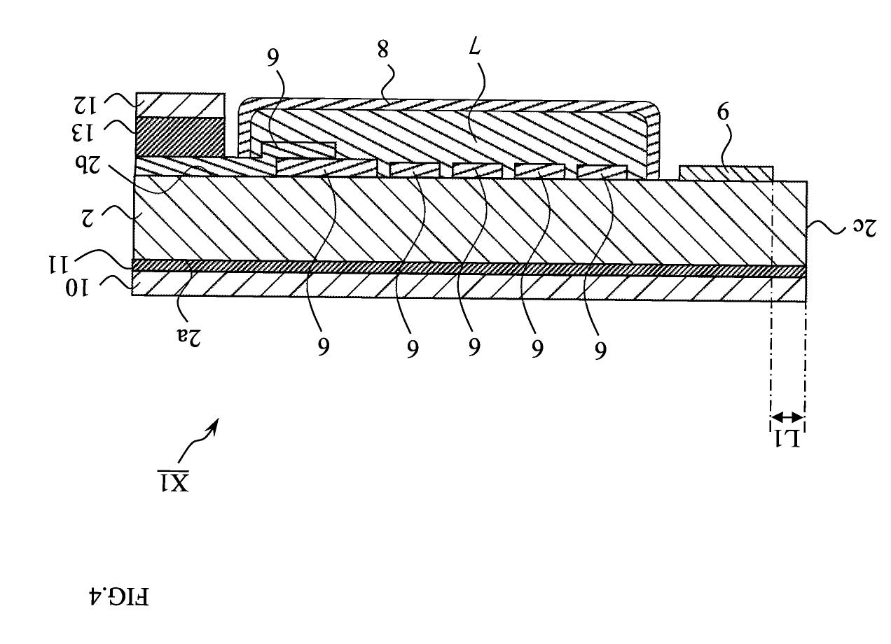

As shown in FIG. 4, detection interconnects 6, an insulating layer 7, a protective layer 8, and a reinforcing member 9 are provided on or above the second main surface 2b of the base 2 in the non-input region E2.

The detection interconnects 6 applies a voltage to the first detection electrodes 3a and the second detection electrodes 4a. The detection interconnects 6 also detect a change in the electrostatic capacitance generated between the finger F1 and the first and second detection electrodes 3a and 4a. In the embodiment shown in FIG. 1, a plurality of detection interconnects 6 are provided on the non-input region E2 positioned along one of the long sides of the base 2 and on the non-input region E2 positioned along one of the short sides of the base 2. One end part of a detection interconnect 6 is electrically connected to the first detection electrode 3a and the second detection electrode 4a, and the other end part thereof is positioned at an external conducting region G1. A flexible board (not shown) is connected to the external conducting region G1. This flexible board is, for example, provided with a position detection driver, which is described later.

The detection interconnects 6 are made of, for example, a metal thin film. To achieve hardness and high shape stability, it is preferable to make the detection interconnects 6 of a metal thin film. Examples of a metal thin film include an aluminum film, an aluminum alloy film, a film laminate of a chromium film and an aluminum film, a film laminate of a chromium film and an aluminum alloy film, a silver film, a silver alloy film, and a gold alloy film. The metal thin film can be formed by, for example, sputtering, CVD (chemical vapor deposition), or another deposition method.

The insulating layer 7 has the function of protecting the detection interconnects 6. The function of protecting the detection interconnects 6 is, for example, the function of protecting the detection interconnects 6 from corrosion caused by the absorption of water. The insulating layer 7 covers the detection interconnects 6. Examples of the constituent material of the insulating layer 7 include acrylic resin, epoxy resin, silicone resin, and urethane resin. The method of forming the insulating layer 7 can be, for example, transfer printing, spin coating, or slit coating.

The insulating layer 7 can be made of the same material as the insulators 5. If the material of the insulating layer 7 is the same as that of the insulators 5, it is possible to form the insulating layer 7 and the insulators 5 simultaneously on the second main surface 2b of the base 2 in the process of manufacturing the input device X1. By doing this, the insulating layer 7 and the insulators 5 can be formed on or above the second main surface 2b of the base 2 without an increase in the number of manufacturing process steps.

The protective layer 8 protects the insulating layer 7. For example, the insulating layer 7 can be protected from corrosion caused by the absorption of water, or a change in the nature of the material of the insulating layer 7. The protective layer 8 covers the insulating layer 7. Examples of the constituent material of the protective layer 8 include silicon dioxide, acrylic resin, epoxy resin, silicone resin, and urethane resin. The protective layer 8 can be formed by, for example, transfer printing, spin coating, or slit coating.

If it is not necessary to protect the insulating layer 7, the protective layer 8 can be omitted.

The reinforcing member 9 is positioned closer to the end face 2c side of the base 2 than the detection interconnects 6. In the embodiment, the reinforcing member 9 is positioned between the detection interconnects 6 and the edge part 21c of the end face 2c of the base 2. The reinforcing member 9 is provided along the edge part 21c of the end face 2c of the base 2. Because the reinforcing member 9 is positioned closer to the end face 2c side of the base 2 than the detection interconnects 6, it is possible to reduce the possibility of a crack growing inside the base 2 that is opposite the input region E1. This will be described specifically below.

In the process of manufacturing an input device, when polishing the end face of the base, there is a possibility of a chip or crack occurring in the end face of the base. When assembling the input device into the display device, there is a possibility that a chip or crack may occur in the end face of the base by contacting of the end face of the base with the enclosure of the display device. In prior art, if a chip occurs in the end face of the base, a crack might grow from the part of the crack toward the inside of the base. Also, if a crack occurs in the end face of the base, the crack might further grow toward the inside of the base. In case of an input devise, because the user repeatedly presses the base, there is a tendency for cracks to grow within the base.

In contrast to the prior art, the input device X1 of the embodiment has the reinforcing member 9 provided closer to the end face 2c side of the base 2 than the detection interconnects 6. Because the reinforcing member 9 is provided closer to the end face 2c side of the base 2 than the detection interconnects 6, even if a chip or crack occurs in the end face 2c of the base 2, the reinforcing member 9 can stop the growth of the crack in the base 2. By doing this, the input device X1 can reduce the possibility of a crack growing inside the base 2.

The constituent material of the reinforcing member 9 can be the same as the constituent material of the first detection electrodes 3a and the second detection electrodes 4a. When the constituent material of the reinforcing member 9 is the same as that of the first detection electrodes 3a and the second detection electrodes 4a, in the process of manufacturing the input device X1, it is possible to simultaneously form the reinforcing member 9 and the first detection electrodes 3a or simultaneously form the reinforcing member 9 and the second detection electrodes 4a on the second main surface 2b of the base 2. By doing this, it is possible to form the reinforcing member 9, the first detection electrodes 3a, and the second detection electrodes 4a on or above the second main surface 2b of the base 2 without an increase in the number of manufacturing process steps.

The constituent material of the reinforcing member 9 can be the same as that of the detection interconnects 6. By adopting this constitution, for the same reason as noted above, it is possible to form the reinforcing member 9 and the detection interconnects 6 on the second main surface 2b of the base 2 without an increase in the number of manufacturing process steps. The constituent material of the reinforcing member 9 can be the same as that of the insulating layer 7. Even with this constitution, for the same reason as noted above, it is possible to form the reinforcing member 9 and the insulating layer 7 on or above the second main surface 2b of the base 2 without an increase in the number of manufacturing process steps.

The reinforcing member 9 can be provided so as to surround the input region E1 when seen in plan view, as shown in FIG. 1. In other words, the reinforcing member 9 can be provided so as to surround the first detection electrodes 3a, the second detection electrodes 4a, and the detection interconnects 6. In this configuration, of the four end faces 2c of the base 2, regardless of in which end face 2c a chip or crack occurs, it is possible to reduce a crack growing within the base 2. The “so as to surround” noted herein does not require the complete surrounding of the input region E1 by the reinforcing member 9. An aperture can be provided in a part of the reinforcing member 9.

As shown in FIG. 4, the reinforcing member 9 can be provided at a distance from the end face 2a of the base 2 that is at least a prescribed distance L1. The prescribed distance L1 means a distance that is the shortest distance from the end face 2c of the base 2 to the reinforcing member 9. In the embodiment, the prescribed distance L1 is 0.4 to 0.6 μm. Because the reinforcing member 9 is provided at a distance from the end face 2c of the base 2 that is at least the prescribed distance L1, even if the end face 2c of the base 2 is polished when manufacturing the input device X1, the reinforcing member 9 can be protected from being peeled from the second main surface 2b of the base 2 at the time of polishing.

When it is not necessary to reduce the possibility of peeling of the reinforcing member 9 from the second main surface 2b of the base 2 at the time of polishing, the reinforcing member 9 can be positioned at the edge part 21c of the end face 2c of the base 2.

As shown in FIG. 2 to FIG. 4, a first protective sheet 10 is provided over the first main surface 2a of the base 2 in the input region E1 and the non-input region E2.

The first protective sheet 10 has the function of protecting so that contacting by the finger F1 of the user does not damage the first main surface 2a of the base 2. The first protective sheet 10 is provided over the entire surface of the first main surface 2a of the base 2, with an adhesive layer 11 intervening therebetween. The first protective sheet 10 can be provided only over the first main surface 2a of the base 2 in the input region E1. The constituent material of the first protective sheet 10 can be, for example, glass, plastic, or a polyethylene terephthalate film. The constituent material of the adhesive layer 11 can be, for example, an acrylic-based adhesive, a silicone-based adhesive, a rubber-based adhesive, or a urethane-based adhesive.

The first protective sheet 10 in the non-input region E2 can be provided with a colored layer. If this constitution is adopted, it is possible to decorate the non-input region E2 of the input device X1.

As shown in FIG. 2 and FIG. 3, a second protective sheet 12 is provided over the second main surface 2b of the base 2 in the input region E1.

The second protective sheet 12 protects the first detection electrodes 3a, the first connection electrodes 3b, the second detection electrodes 4a, and the second connection electrodes 4b. The second protective sheet 12 is provided over the second main surface 2b of the base 2, with an adhesive layer 13 intervening therebetween. The same types of materials noted with regard to the first protective sheet 10 can be used as the second protective sheet 12, and the same types of materials as noted with regard to the adhesive layer 11 can be used as the adhesive layer 13.

Next, the detection principle in the input device X1 will be described.

A position detection driver (not shown) is electrically connected to the detection interconnects 6 positioned at the external conducting region G1. The position detection driver has a power supply section. The power supply section of the position detection driver supplies a voltage to the first detection electrodes 3a and the second detection electrodes 4a. In this case, when the finger F1, which is a conductor, comes into proximity to the first main surface 2a of the base 2 in the input region E1, an electrostatic capacitance is generated between the finger Fl and the first and second detection electrodes 3a and 4a. The position detection driver constantly detects the electrostatic capacitance generated at the first detection electrodes 3a and the second detection electrodes 4a. The position detection driver detects the input position at which the user performed an input operation, from the combination of a first detection electrode 3a and a second detection electrode 4a at which an electrostatic capacitance exceeding a prescribed value is detected. In this manner, the input device X1 can detect the input position.

As described above, the input device X1 can reduce the possibility of the growth of a crack inside the base 2. For this reason, it can maintain the strength of the base 2. Even if water or the like intrudes from a crack, the intruding water and the like can be prevented from reaching the detection interconnects 6 and, for this reason, the possibility of corrosion of the detection interconnects 6 occurring can be reduced. As a result, there is an improvement in the reliability of the input device X1.

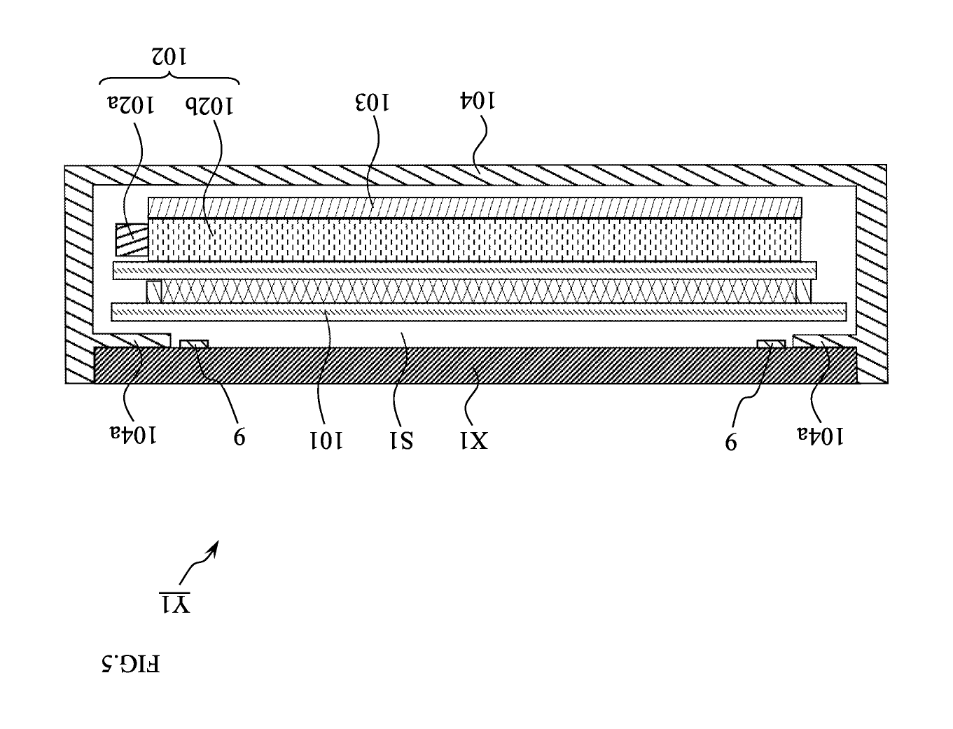

Next, a display device Y1 that has the input device X1 will be described, with reference to FIG. 5.

As shown in FIG. 5, the display device Y1 as an embodiment has the input device X1, a liquid-crystal panel 101, a backlight 102, a circuit board 103, and a first enclosure 104.

The liquid-crystal panel 101 is a display panel that uses a liquid-crystal composition for displaying. The liquid-crystal panel 101 arranged to face the input device X1, with a space S1 intervening therebetween. A plasma panel, an organic EL panel, electronic paper, or the like can be used instead of the liquid-crystal panel 101. In this case, the organic EL panel is a display panel in which a substance is used that emits light when a voltage is applied thereto. Specifically, an organic EL panel has a light-emitting body using an organic substance such as a diamine or the like, which is vapor deposited onto a substrate, and which displays when a DC voltage of 5 to 10 V is applied thereto. If an organic EL panel is used in place of the liquid-crystal panel 101, the backlight 102 is unnecessary.

The backlight 102 has a light source 102a and a light-guiding sheet 102b. The light source 102a shines light toward the light-guiding sheet 102b. The light source 102a can be, for example, an LED (light-emitting diode). In place of the LED, a cold-cathode fluorescent lamp, a halogen lamp, a xenon lamp, or EL (electro-luminescence) can be used. The light-guiding plate 102b guides the light from the light source 102a substantially uniformly over the entire lower surface of the liquid-crystal panel 101.

The circuit board 103 is a plate-like or film-like board onto the surface of which components such as ICs (integrated circuits), resistors, and capacitors are mounted, and which constitutes an electronic circuit by connecting with interconnects these components. The circuit board 103 is disposed on the rear surface side of the backlight 102. A connector is also provided on the circuit board 103. The flexible board that is connected to the external conducting region G1 is inserted into this connector.

The first enclosure 104 houses the liquid-crystal panel 101, the backlight 102, and the circuit board 103. Examples of the constituent material of the first enclosure 104 are resins such as a polycarbonate, or metals such as stainless steel or aluminum.

The first enclosure 104 includes a supporting member 104a. The supporting member 104a supports the input device X1. Specifically, the supporting member 104a supports the non-input region E2 to surround the input region E1. The input device X1 and the supporting member 104a are adhered together by an adhesive member such as double-sided tape. The reinforcing member 9 in the input device X1 is provided further to the inside than the supporting member 104a. That is, the reinforcing member 9 is provided closer to the end face 2c side of the base 2 than the detection interconnects 6 and also further to the inside than the supporting member 104a. Specifically, the reinforcing member 9 is positioned between the detection interconnects 6 and the edge part 21c of the end face 2c of the base 2, and also further to the inside than the supporting member 104a.

In this manner, by performing an input operation in the input region E1 while looking through to the liquid-crystal panel 101, it is possible to input various information. Additional functions can be imparted to the input device X1 such that the user inputting data is provided with a tactile push feeling, a feeling of tracing, or a texture feeling or the like. In the case of providing one or more piezoelectric elements to the base 2 in the input device X1 to detect a prescribed input operation or pressure load, this can be implemented by causing the piezoelectric elements to vibrate at a prescribed frequency.

Because the display device Y1 has the input device X1, it can reduce the possibility of a crack growing inside the base 2 of the input device X1. For this reason, the reliability of the display device Y1 is improved.

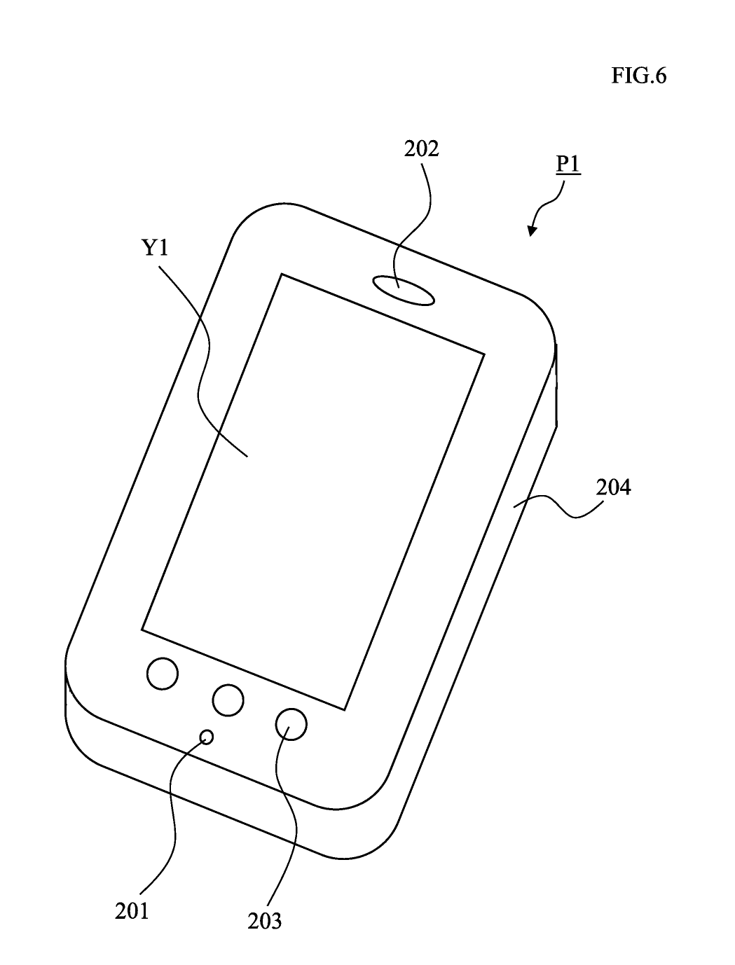

Next, a portable terminal P1 having the display device Y1 will be described, with references being made to FIG. 6.

As shown in FIG. 6, the portable terminal P1 as an embodiment is an electronic device such as a mobile telephone, a smartphone, or a PDA (personal digital assistant). The portable terminal P1 has the display device Y1, a voice input section 201, a voice output section 202, a key input section 203, and a second enclosure 204.

The voice input section 201 is constituted by, for example, a microphone or the like, and inputs a voice or the like of a user. The voice output section 202 is constituted by, for example, a speaker, and outputs the voice or the like of the other party. The key input section 203 is constituted by, for example, mechanical keys, and the key section 203 can be operating keys displayed on a display screen. The second enclosure 204 houses the display device Y1, the voice input section 201, the voice output section 202, and the key input section 203.

As necessary, the portable terminal P1 can be provided with a digital camera function section, a one-segment broadcast tuner, a short-range wireless communication section such as an infrared communication function section, and various interfaces and the like. Detailed illustrations and descriptions thereof are omitted.

Because the portable terminal P1 includes the display device Y1, it can reduce the possibility of a crack growing inside the base 2 in the input device X1 provided in the display device Y1. For this reason, the reliability of the portable terminal P1 is improved.

Although the above configuration is an example in which the voice input section 201 is provided in the portable terminal P1, the invention is not limited thereto. That is, the portable terminal P1 need not have the voice input section 201.

Additionally, although in the foregoing example the portable terminal P1 has a second enclosure 204 that houses the display device Y1, the voice input section 201, the voice output section 202, and the key input section 203, the invention is not limited thereto. The first enclosure 104 in the display device Y1 can serve as an enclosure for the portable terminal P1, without providing a separate second enclosure 204.

Additionally, the display device Y1, rather than a portable terminal P1, can be provided in a variety of electronic devices, such as programmable display devices for industrial use, a vehicle-borne display unit, an electronic diary, a personal computer, a copier, a game terminal, a television, or a digital camera.

The above-described embodiments show one specific example of the embodiment of the present invention, and various changes can be implemented thereto. Several main variation examples will be shown, below.

### Variation Example 1

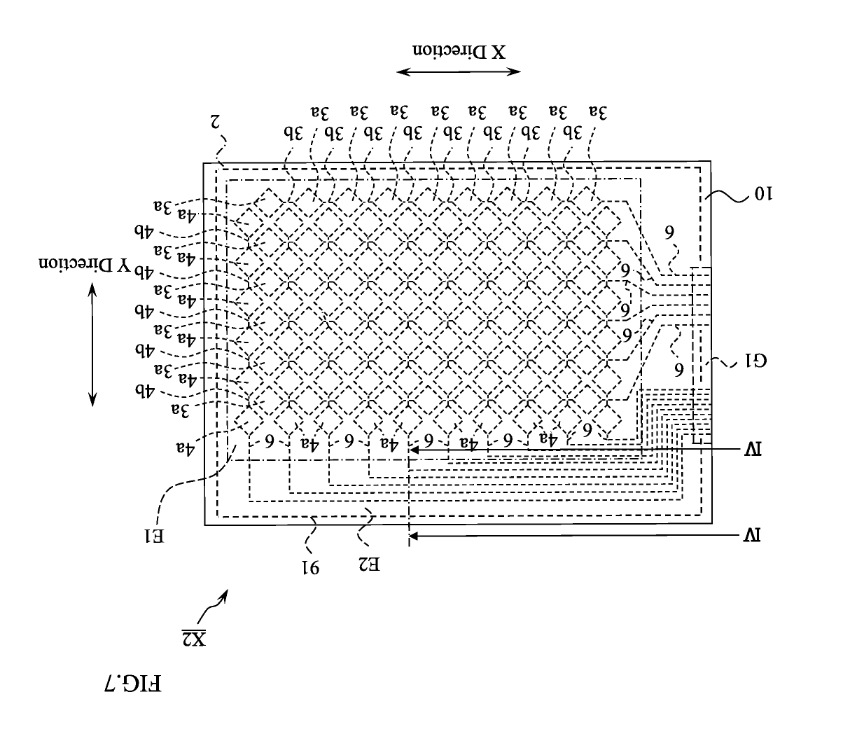

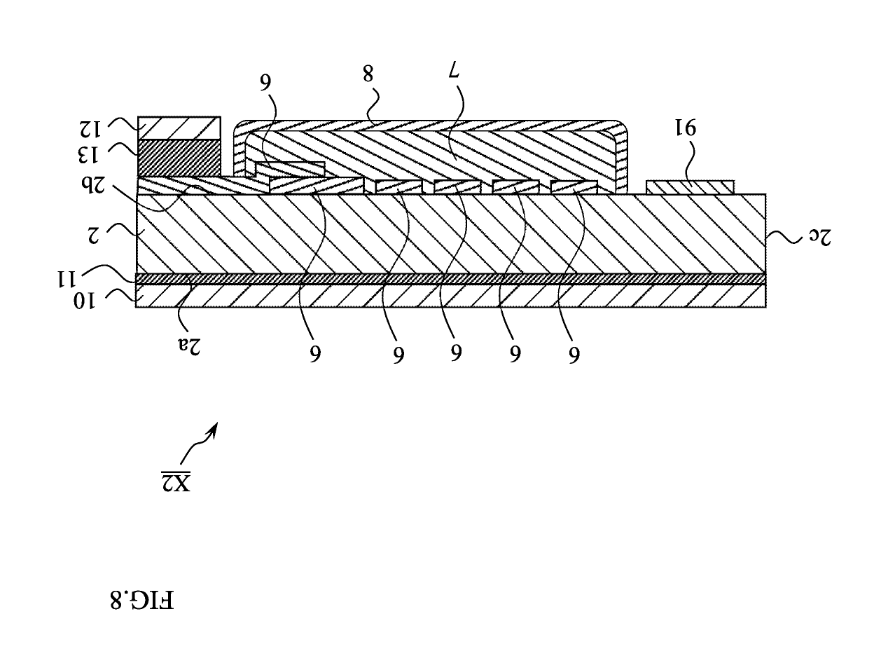

FIG. 7 is a plan view showing the general constitution of an input device X2 according to a variation example 1. FIG. 8 is a cross-sectional view along the cutting line IV-IV shown in FIG. 7. In FIG. 7 and FIG. 8, elements that have the same functions as those in FIG. 1 and FIG. 4 are assigned the same reference symbols and are not described in detail herein.

As shown in FIG. 7 and FIG. 8, in the input device X2, in place of the reinforcing member 9 described with regard to the embodiment described above, a reinforcing member 91 is provided. The reinforcing member 91 is positioned closer to the end face 2c of the base 2 than the detection interconnects 6 and the reinforcing member 91 is electrically conductive. For this reason, the constituent material of the reinforcing member 91 is either the same as the constituent material of the first detection electrodes 3a and second detection electrode 4a or the same as the constituent material of the detection interconnects 6. The reinforcing member 91 is set to a reference electrical potential.

Because the reinforcing member 91 is electrically conductive and also is set to a reference electrical potential, it is possible to block noise generated outside by the reinforcing member 91. Because it is possible for the reinforcing member 91 to block externally generated noise, it is possible to reduce the effect of external noise on the first detection electrodes 3a, the second detection electrodes 4a, and the detection interconnects 6. For this reason, it is possible to reduce the possibility of a reduction in the detection accuracy or detection sensitivity of the input device X2.

In order to effectively block externally generated noise by the reinforcing member 91, it is preferable to set the reinforcing member 91 to the ground potential.

Also, the reinforcing member 91 can be provided, as shown in FIG. 7, so as to surround the input region E1 when seen in plan view. That is, the reinforcing member 91 can be provided to surround the first detection electrodes 3a, the second detection electrodes 4a, and the detection interconnects 6. By adopting this constitution, regardless of from what direction noise is generated around the input device X2, it is possible for the reinforcing member 91 to block the noise.

As described above, the input device X2 can reduce the possibility that a crack will grow inside the base 2. For this reason, the reliability of the input device X2 is improved. Additionally, in the input device X2, externally generated noise can be blocked by the reinforcing member 91. For this reason, it is possible to reduce the possibility of a reduction in the detection accuracy or detection sensitivity of the input device X2.

### Variation Example 2

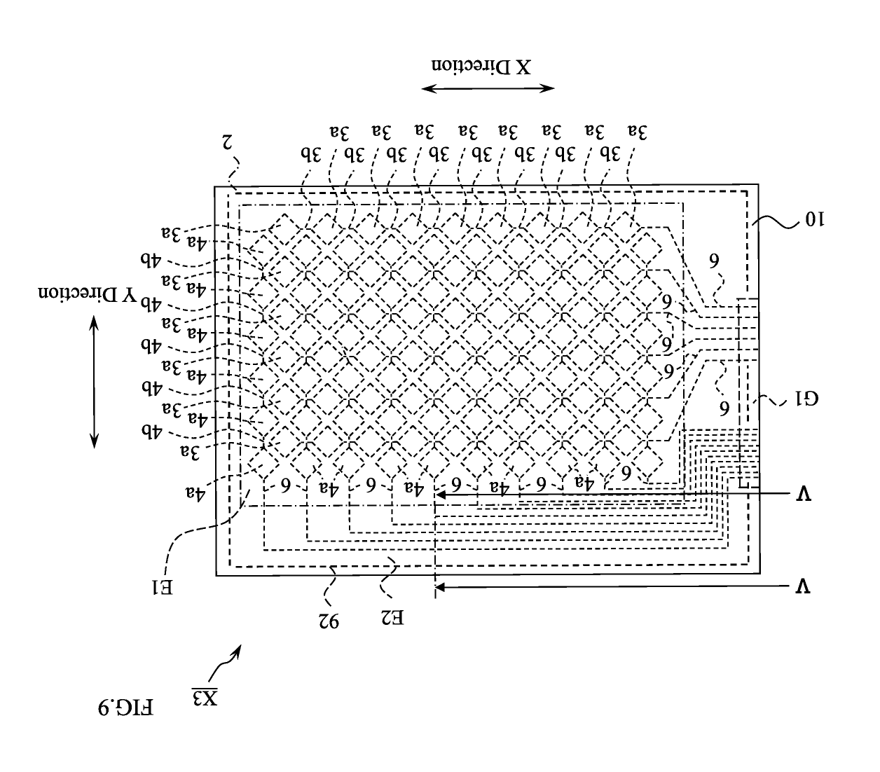

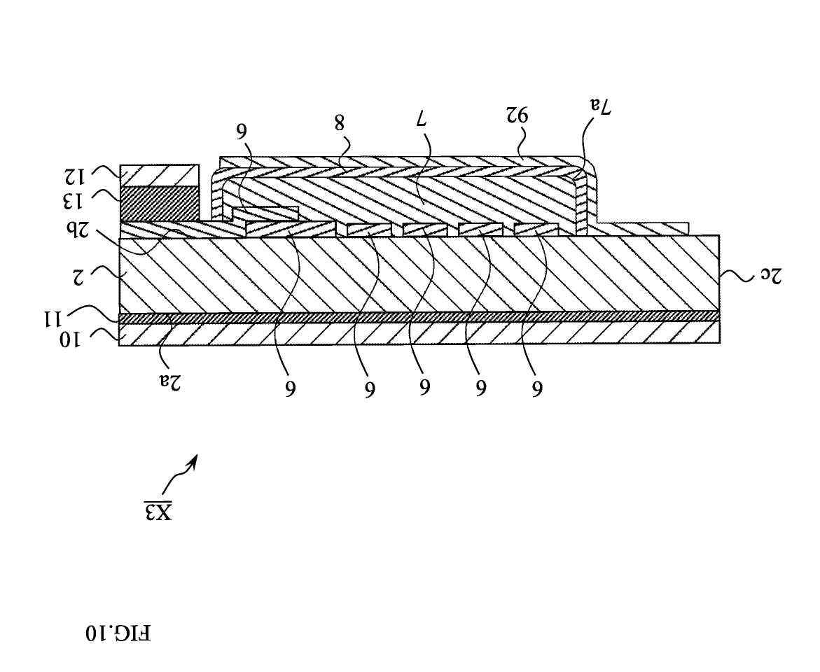

FIG. 9 is a plan view showing the general constitution of an input device X3 according to a variation example 2. FIG. 10 is a cross-sectional view along the cutting line V-V shown in FIG. 9. In FIG. 9 and FIG. 10, elements that have the same functions as those in FIG. 7 and FIG. 8 are assigned the same reference symbols and are not described in detail herein.

As shown in FIG. 9 and FIG. 10, in the input device X3, in place of the reinforcing member 91 described with regard to the variation example 1 above, a reinforcing member 92 is provided. The reinforcing member 92 is electrically conductive and also is set to a reference electrical potential, similar to the reinforcing member 91. The difference with respect to the reinforcing member 91, however, is that the reinforcing member 92 extends over the insulating layer 7 from over the second main surface 2b of the body 2. Specifically, the reinforcing member 92 extends over the protective layer 8 provided on the insulating layer 7, so as to cover the detection interconnects 6.

In this case, when a liquid-crystal panel operates by active matrix drive, in order to suppress the voltage amplitude on the data interconnects, a voltage of a common electrode provided on the base of the liquid-crystal panel is alternatively switched between a low voltage and a high voltage. Accompanying the voltage switching with respect to the common electrode, noise is generated form the liquid-crystal panel. For this reason, after incorporating the input device into the display device, when the liquid-crystal panel is caused to be AC driven, noise generated from the liquid-crystal panel affects the detection interconnects of the input device. For this reason, the detection accuracy or detection sensitivity of the input device X3 is reduced.

Given this, if the reinforcing member 92 extends on the insulating layer 7 from on the second main surface 2b of the body 2, as in the input device X3 according to the variation example 2, the reinforcing member 92 can block noise generated in the liquid-crystal panel 101. Because it is possible for the reinforcing member 92 to block noise generated in the liquid-crystal panel 101, it is possible to reduce the effect of noise from the liquid-crystal panel 101 with respect to the the detection interconnects 6. For this reason, it is possible to reduce the possibility of a reduction in the detection accuracy or detection sensitivity of the input device X3.

In order to block noise generated in the liquid-crystal panel 101 effectively by the reinforcing member 92, it is preferable to set the reinforcing member 92 to the ground potential.

As described above, in the input device X3, it is possible to reduce the possibility that a crack will grow inside the base 2. For this reason, the reliability of the input device X3 is improved. Additionally, in the input device X3, noise generated in the liquid-crystal panel 101 can be blocked by the reinforcing member 92. For this reason, it is possible to reduce the possibility of a reduction in the detection accuracy or detection sensitivity of the input device X3.

Additionally, as shown in FIG. 10, the end part 7a of the insulating layer 7 is preferably a curved surface. If the end part 7a of the insulating layer 7 forms a curved surface, it is possible to reduce the possibility of peeling of the reinforcing member 92 positioned at the end part 7a of the insulating layer 7 from the protective layer 8 positioned on the insulating layer 7.

### Variation Example 3

Although, in the above example, the input devices X1 to X3 are described for the case in which the finger F1 is brought into contact with the first protective sheet 10 so as to perform an input operation, this is not be restricted. The input device can be such that the finger F1 is brought into contact with the second protective sheet 12 so as to perform an input operation.

### Variation Example 4

Although in the above example the display device Y1 having the input device X1 is described, instead of the input device Xl, the input device X2 or input device X3 can be used. A mobile terminal can be provided with a display device using the input device X2 or the input device X3. An arbitrary combination of the above-described embodiments and the above-described variations is also possible.

What is claimed is:

1. An input device comprising:
a base;
a detection electrode provided on or above the base;
a detection interconnect provided on or above the base and electrically connected to the detection electrode; and
a reinforcing member provided on or above the base and positioned closer to end face side of the base than the detection interconnect.

2. The input device according to claim 1, wherein the reinforcing member is provided so as to surround the detection electrode and the detection interconnect.

3. The input device according to claim 1, wherein the reinforcing member is provided spaced at least a prescribed distance from the end face of the base.

4. The input device according to claim 1, wherein the reinforcing member is electrically conductive and is set to a reference potential.

5. The input device according to claim 4, wherein the reinforcing member is provided so as to surround the detection electrode and the detection interconnect.

6. The input device according to claim 4, further comprising an insulating layer provided on or above the base and covering the detection interconnect,
wherein the reinforcing member extends from the base over the insulating layer.

7. An input device having an input region and a non-input region; the input device comprising:
a base having a first main surface, a second main surface positioned on the opposite side from the first main surface, and an end face positioned between the first main surface and the second main surface;
a detection electrode provided on or above the second main surface of the base in the input region;
a detection interconnect provided on or above the second main surface of the base in the non-input region and electrically connected to the detection electrode; and
a reinforcing member provided on or above the second main surface of the base in the non-input region and positioned between the detection interconnect and the end part of the end face of the base.

8. The input device according to claim 7, wherein the reinforcing member is provided along the end part of the end face of the base.

9. A display device comprising:
the input device according to claim 1;
a display panel arranged to face the input device; and
an enclosure housing the display panel.

10. The display device according to the claim 9, wherein the display panel is a liquid-crystal panel or an organic EL panel.

11. An electronic device comprising the display device according to claim 9.

12. An input device comprising:
a base having a first surface, a second surface and an end surface, the first surface being opposite to the second surface, the end surface extending between the first surface and the second surface, the base being transparent and insulating;
an detection electrode provided on or above a first area of the second surface, the detection electrode being transparent;
a detection wiring provided on or above a second area of the second surface, the detection wiring electrically connected to the detection electrode; and
a reinforcing member provided on or above the second area of the second surface between the detection wiring and a periphery of the end surface.

13. The input device of claim 12, wherein the reinforcing member is provided along the periphery of the end surface.

14. The input device of claim 12, wherein the reinforcing member is also provided in the first area such that the reinforcing member surrounds the detection electrode and the detection wiring.
